(19) United States
(12) Patent Application Publication
(10) Pub. No.: US 2004/0050100 A1
(43) Pub. Date: Mar. 18, 2004

(54) Method of making a foamed glass composite panel and use therefor

(75) Inventors: Andrew Ungerleider, Santa Fe, NM (US); Steven Haines, Santa Fe, NM (US)

Correspondence Address: ROBERT W. BECKER & ASSOCIATES, Suite B, 707 Highway 66 East, Tijeras, NM, 87059, US

(73) Assignee: Earthstone International, LLC, Santa Fe, NM

(21) Appl. No.: 10/244,640

(22) Filed: Sep. 16, 2002

(51) Int. Cl. C03B 19/08

(52) U.S. Cl. 65/22; 65/17.3; 65/17.6; 65/55; 65/20

(57) ABSTRACT

A method of producing a foamed glass composite panel is provided. Glass and 0.1-20.0% by weight of at least one non-sulfur based foaming agent are mixed together, and the mixture is heated to a temperature sufficient to foam it. The foamed mixture is cooled to form at least one foamed glass substrate. During or after the cooling step, material is bonded or attached to at least one side of the foamed glass substrate to form a composite panel.

### BACKGROUND OF THE INVENTION

The present invention relates to the use of foamed glass as a substrate in a composite panel, such as a building panel, the various uses of and a method of making such a product.

Composite panels for the building industry using plastic foam materials have been used for years. SIP's (Structural Insulated Panel) and EIFS (Exterior Insulating Finishing System) panels and the like are being used more and more in the building industry. Panel use at the building site allows for increased speed and productivity of assembly. Almost all of the building panels in production today use some type of plastic or hydrocarbon foam in a sandwich of more rigid materials. Although light weight and relatively inexpensive, these panels have many drawbacks. Plastic and hydrocarbon based foam material is made from a finite raw material source who's price rises as availability declines. Such foam deteriorates in the environment, is susceptible to damage by insects, rodents or moisture, is flammable and produces toxic fumes when burned. In addition, the manufacture of plastic and hydrocarbon foams creates environmentally damaging residues that require costly disposal measures. There is a need for a composite building panel with a substrate other than plastic or hydrocarbon foam.

It is therefore an object of the present invention to provide a composite panel, and a method of making the same, that overcomes the drawbacks of plastic and hydrocarbon foam panels.

This object, and other objects and advantages of the present invention, will appear more clearly from the following specification and the accompanying Examples.

### SUMMARY OF THE INVENTION

The present invention provides for the use of a foamed glass substrate bonded mechanically or chemically on at least one side to one or more flexible or rigid membranes, creating a panel of a desired shape or size used primarily for, but not limited to, the building industry. The foamed glass substrate is composed of a single or multiple pieces derived from a starting mixture that comprises virgin or waste glass derived from but not limited to pre-consumer manufacturing, post-consumer waste or specifically designed virgin glass and 0.1-20.0%, and preferably 0.5-5.0%, by weight of a non-sulfur based foaming agent such as, but not limited to, barium carbonate, calcium carbonate, magnesium carbonate, sodium carbonate, sugar, urea and mixtures thereof. The homogeneously blended mixture is placed on a surface that can be a belt or plate, with a mold being the preferred method of containment. The mixture and containment are heated, for example to 1250-1700° F., so that the mixture sinters and subsequently foams. The foamed mixture is then annealed and cooled to room temperature to produce a foamed substrate product, so-called white foamed glass. The mold can be a single or multi-piece design made of, but not limited to, metal, ceramic composite or the like. The mold size can be as large as the finished panel size or composed of smaller molds creating modular substrate pieces that would be combined to make up a larger panel. Additional ingredients can be added to the mixture to increase the foam glass substrate characteristics to benefit the specifically designed composite panel. The glass, such as, by way of example only, soda lime glass, borosilicate glass, and aluminosilicate glass, is preferably powdered or ground, having, for example, an average particle size distribution that ranges from 1-500 p, prior to being mixed with the foaming agent. For more background regarding the preparation of white foamed glass, reference is made, for example, to U.S. Pat. No. 5,972,817, Haines et al.

Using open and/or closed pore foamed glass as a substrate or substrates in a composite building panel obviates the disadvantages of the current plastic foam. The raw materials are readily available, with an added benefit in the case of recycled material, much of which is ending up in landfills. A foamed glass substrate is highly desirable with regard to resistance to fire, vermin, aging, infiltration and environmental factors. In addition, foamed glass can be formulated for increased insulation value, high impact strength and resistance to high temperature. A composite or sandwich structure with a foam glass substrate creates a panel having greater shear and tensile strength, whereas foam glass alone is prone to cracking in shipping and in use on job sites. Many types of materials can be used to create the composite sandwich in conjunction with a foam glass substrate. Rigid and flexible membranes along with sprayed or painted on material can be applied to increase the usefulness of foam glass alone. Foam glass can be easily and inexpensively manufactured and, when using recycled glass in the substrate, is very competitive compared to foamed plastics and hydrocarbons. Use of recycled glass in production can also reduce waste in landfills.

Although so-called black or carbon/sulfur foaming agent based foam glass has been known for uses of insulation and abrasion, it is not suitable for composite building panels due to the low density and weak, brittle structural strength. In addition, and due to the chemistry and pore structure, the black foam glass releases noxious gases of carbon monoxide, hydrogen sulfide and sulfur dioxide. These gases can cause health hazards and contribute to environmental degradation by acid rain.

Additionally, the present invention provides for the assembly of a structural or non-structural building panel comprised of a layer or layers of a foam glass substrate attached, mechanically or chemically, to at least one side of a membrane functioning as a vapor barrier, protective layer, internal or external decorative or structural cladding and the like. Examples of membranes can include layers of rigid and flexible material, including sprayed or painted on material, such as, but not limited to, wood, plastic, metal, limestone, marble, granite, paper, glass, nylon, fiberglass, polyurethane, adhesives, paint, high performance finishes, textured coatings and the like. Membranes are bonded chemically or mechanically to the foam glass substrate to create the sandwich; adhesives can also be used between layers. Specific panel applications can include structural and non-structural wall panels, exterior and interior sheathing, flooring, roofing and the like in the building and other industries. Along with attached membranes chosen for specific qualities, the foam glass substrate can be formulated for a specific application thereby increasing the potential superiority and range of a particular panel. Along with the naturally occurring properties of foam glass of resistance to fire, vermin, aging and infiltration, foam substrate layers can be made for closed-cell foam glass for infiltration damage, light weight foam glass for applications of weight restrictions or buoyancy applications, insulating foam glass for increased R-value or sound insulation properties, extra dense or hard foam glass for penetration damage or structural properties, decorative, colored, textured or protective skin on a foamed glass substrate for exposed building roof and wall panels and the like. Besides the lower cost of manufacture of composite cladding panels using foamed glass substrates, other improvements include increased thermal efficiency and lower operating costs than for those known claddings made of brick, precast, glass or granite. Single or multiple layers of foam glass substrates can be tailored with a membrane or membranes to change performance to create superior, more adaptable and less expensive composite building panels that outperform existing plastic or hydrocarbon foam panels. In addition, a single foam glass substrate can be produced to contain multiple layers with different formulated attributes for specific applications.

### EXAMPLE 1

A foam glass substrate of light weight material was produced by mixing together 17.784 kg. (98.8%) light bulb plate glass, minus 325 mesh and 216 g. (1.2%) calcium carbonate, minus 200 mesh. The mixture was put into a ceramic mold 16″×48″ and fired to 1450° F. to foam. After removal from the mold, the top was cut flat to the final dimensions of 4″×16″×48″. The resulting foam glass substrate was bonded to one layer of ½″ wafer board on one side and nylon stucco mesh on the other to be used as an exterior wall sheathing panel.

### EXAMPLE 2

A foam glass substrate of insulating material was produced by mixing together 4.825 kg. (96.5%) recycled plate glass, minus 200 mesh, 75 g. (1.5%) calcium carbonate, minus 200 mesh and 100 g. (2%) of zinc oxide, minus 150 mesh. The mixture was put into a ceramic mold 13″×18″ and fired to 1475° F. to foam. After removal from the mold, the top, sides and bottom were cut to a final dimension of 2″×12″×16″. Twenty-four substrate modules were chemically attached together and bonded on one side to ½″×4′×8′ drywall board to create an interior sound deadening wall panel.

### EXAMPLE 3

A foam glass substrate of extra penetration strength and resistance to fire was produced by mixing together 6.069 kg. (89.25%) recycled bottle glass, minus 150 mesh, 51 g. (1.5%) calcium carbonate, minus 200 mesh and 680 g. (10%) zinc oxide, minus 150 mesh. The mixture was put into a ceramic mold 13″×18″ and fired to 1485° F. to foam. After removal from the mold, the top, sides and bottom were cut to a final dimension of 4″×12″×16″. Twenty-four substrate modules were chemically attached together and bonded on one side with 26 g. 4′×8′ commercial steel siding sheet and on the other with ⅝″ drywall board to create an exterior wall panel for a battery storage building.

### EXAMPLE 4

An insulating foam glass substrate with a decorative and protective exterior skin was produced by mixing together 19.5 kg. (97.5%) bottle glass, minus 200 mesh, 500 g. (2.5%) calcium carbonate, minus 325 mesh. A decorative layer was produced by mixing together 5 g. (0.5%) copper carbonate, 500 g. (50%) sodium bicarbonate and 455 g. (45.5%) light bulb glass, minus 325 mesh. The insulating substrate mixture was put into a ceramic mold 16″×48″ and the decorative mixture sifted on top and fired to 1500° F. to foam. After removal from the mold, the bottom was cut to the final dimensions of 4″×16″×48″. The resulting foam glass substrate was bonded to one layer of ½″ wafer board on the bottom to create a decorative exterior insulated sheathing panel.

The present invention is, of course, in no way restricted to the specific disclosure of the specification and examples, but also encompasses any modifications within the scope of the appended claims.

What we claim is:

1. A method of producing a composite panel, including the steps of:
mixing together glass and 0.1-20.0% by weight of at least one non-sulfur based foaming agent to form a mixture;
heating said mixture to a temperature sufficient to foam said mixture;
cooling said foamed mixture to form at least one foamed glass substrate; and
during or after said cooling step, bonding or attaching material to at least one side of said at least one foamed glass substrate to form said composite panel.

2. A method according to claim 1, wherein said at least one foaming agent is selected from the group consisting of barium carbonate, calcium carbonate, magnesium carbonate, sodium carbonate, sugar, urea, and mixtures thereof.

3. A method according to claim 1, wherein said glass is selected from the group consisting of waste glass and virgin glass.

4. A method according to claim 3, which includes the further step of providing said glass in ground or powdered form prior to said mixing together step.

5. A method according to claim 1, wherein said foaming agent is present at 0.5-5.0% by weight.

6. A method according to claim 1, wherein said heating step comprises heating said mixture to a temperature of between 1250 and 1700° F.

7. A method according to claim 1, wherein said material is selected from the group consisting of rigid and flexible material.

8. A method according to claim 7, wherein said material is at least one of the group consisting of wood, plastic, metal, limestone, marble, granite, paper, glass, nylon, fiberglass, polyurethane, adhesives, paint, high performance finishes, and textured coatings.

9. A method according to claim 7, wherein said material is chemically or mechanically attached.

10. A method according to claim 1, wherein said material is sprayed or painted on.

11. A method according to claim 1, wherein a first material is bonded or attached to one side of said at least one substrate, and the same or a different material is bonded or attached to an opposite side of said at least one substrate.

12. A method according to claim 1, wherein said substrate is a single or multiple members, in the same or parallel planes.

13. A method according to claim 1, wherein said substrate contains a plurality of layers having different attributes.

14. A composite panel made by the method of claim 1.

15. The use of a composite panel as a building panel, comprising the steps of:
mixing together glass and 0.1-20.0% by weight of at least one non-sulfur based foaming agent to form a mixture;
heating said mixture to a temperature sufficient to foam said mixture;
cooling said foamed mixture to form at least one foamed glass substrate;
during or after said cooling step, bonding or attaching material to at least one side of said at least one foamed glass substrate to form said composite panel, and;
using said composite panel as a building panel.
